(19) United States
(12) Patent Application Publication
(10) Pub. No.: US 2017/0290031 A1
(43) Pub. Date: Oct. 5, 2017

(54) METHOD OF TRANSMITTING SCHEDULING REQUEST SIGNAL IN NEXT GENERATION WIRELESS COMMUNICATION SYSTEM AND APPARATUS THEREFOR

(71) Applicant: LG ELECTRONICS INC., Seoul (KR)

(72) Inventors: Daesung HWANG, Seoul (KR); Seungmin LEE, Seoul (KR); Yunjung YI, Seoul (KR)

(73) Assignee: LG ELECTRONICS INC., Seoul (KR)

(21) Appl. No.: 15/470,557

(22) Filed: Mar. 27, 2017

Related U.S. Application Data
(60) Provisional application No. 62/314,960, filed on Mar. 29, 2016.

(51) Int. Cl. H04W 72/12

(52) U.S. Cl. CPC H04W 72/121; H04W 72/1268; H04W 72/1289; H04W 72/1226

(57) ABSTRACT

A method for a base station to transmit and receive a signal in a wireless communication system is disclosed in the present specification. Specifically, the method includes the steps of receiving at least one SR signal in an SR (scheduling request) transmission resource configured for a plurality of UEs, selecting at least one UE for transmitting an uplink grant based on the at least one SR signal, and transmitting the uplink grant to the at least one UE.

Pursuant to 35 U.S.C. §119(e), this application claims the benefit of the U.S. Provisional Patent Application No. 62/314,960, filed on Mar. 29, 2016, which is hereby incorporated by reference as if fully set forth herein.

### BACKGROUND OF THE INVENTION

### Field of the Invention

The present invention relates to a wireless communication system, and more particularly, to a method of transmitting a scheduling request signal in a next generation wireless communication system and an apparatus therefor.

### Discussion of the Related Art

A brief description will be given of a 3rd Generation Partnership Project Long Term Evolution (3GPP LTE) system as an example of a wireless communication system to which the present invention can be applied.

FIG. 1 illustrates a configuration of an Evolved Universal Mobile Telecommunications System (E-UMTS) network as an exemplary wireless communication system. The E-UMTS system is an evolution of the legacy UMTS system and the 3GPP is working on the basics of E-UMTS standardization. E-UMTS is also called an LTE system. For details of the technical specifications of UMTS and E-UMTS, refer to Release 7 and Release 8 of “3rd Generation Partnership Project; Technical Specification Group Radio Access Network”, respectively.

Referring to FIG. 1, the E-UMTS system includes a User Equipment (UE), an evolved Node B (eNode B or eNB), and an Access Gateway (AG) which is located at an end of an Evolved UMTS Terrestrial Radio Access Network (E-UTRAN) and connected to an external network. The eNB may transmit multiple data streams simultaneously, for broadcast service, multicast service, and/or unicast service.

A single eNB manages one or more cells. A cell is set to operate in one of the bandwidths of 1.25, 2.5, 5, 10, 15 and 20 Mhz and provides Downlink (DL) or Uplink (UL) transmission service to a plurality of UEs in the bandwidth. Different cells may be configured so as to provide different bandwidths. An eNB controls data transmission and reception to and from a plurality of UEs. Regarding DL data, the eNB notifies a particular UE of a time-frequency area in which the DL data is supposed to be transmitted, a coding scheme, a data size, Hybrid Automatic Repeat reQuest (HARQ) information, etc. by transmitting DL scheduling information to the UE. Regarding UL data, the eNB notifies a particular UE of a time-frequency area in which the UE can transmit data, a coding scheme, a data size, HARQ information, etc. by transmitting UL scheduling information to the UE. An interface for transmitting user traffic or control traffic may be defined between eNBs. A Core Network (CN) may include an AG and a network node for user registration of UEs. The AG manages the mobility of UEs on a Tracking Area (TA) basis. A TA includes a plurality of cells.

While the development stage of wireless communication technology has reached LTE based on Wideband Code Division Multiple Access (WCDMA), the demands and expectation of users and service providers are increasing. Considering that other radio access technologies are under development, a new technological evolution is required to achieve future competitiveness. Specifically, cost reduction per bit, increased service availability, flexible use of frequency bands, a simplified structure, an open interface, appropriate power consumption of UEs, etc. are required.

### SUMMARY OF THE INVENTION

Accordingly, the present invention is directed to an apparatus and method thereof that substantially obviate one or more problems due to limitations and disadvantages of the related art.

An object of the present invention is to provide a method of transmitting a scheduling request signal in a next generation wireless communication system and an apparatus therefor based on the aforementioned discussion.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a method for a base station to transmit and receive a signal in a wireless communication system includes the steps of receiving at least one SR signal in an SR (scheduling request) transmission resource configured for a plurality of UEs, selecting at least one UE to transmit a UL grant based on the at least one SR signal, and transmitting the UL grant to the at least one UE.

To further achieve these objects and other advantages and in accordance with the purpose of the invention, as embodied and broadly described herein, according to a different embodiment, a base station in a wireless communication system includes a wireless communication module, and a processor configured to be connected with the wireless communication module, the processor configured to receive at least one SR signal in an SR (scheduling request) transmission resource configured for a plurality of UEs, the processor configured to select at least one UE to transmit a UL grant based on the at least one SR signal, the processor configured to transmit the UL grant to the at least one UE.

Preferably, it is able to receive a UL data signal from the at least one UE based on the UL grant. In this case, the at least one UE may correspond to a UE which have transmitted the at least one SR signal.

Preferably, it is able to configure a resource for UL data signal transmission of the plurality of the UEs via a higher layer signal. In this case, the UL grant can include activation information of the UL data signal transmission.

More preferably, the at least one SR signal can include information on an identifier of a UE which have transmitted the SR signal.

In addition, the at least one UE can be selected based on channel state information corresponding to the plurality of the UEs.

To further achieve these objects and other advantages and in accordance with the purpose of the invention, as embodied and broadly described herein, according to a different embodiment, a method of transmitting and receiving a signal, which is transmitted and received by a UE belonging to a UE group in a wireless communication system, includes the steps of transmitting an SR signal to a base station in an SR (scheduling request) transmission resource configured for the UE group, receiving a UL grant from the base station, and transmitting a UL data signal based on the UL grant. In this case, the SR signal can include information on an identifier of the UE.

To further achieve these objects and other advantages and in accordance with the purpose of the invention, as embodied and broadly described herein, according to a further different embodiment, a user equipment in wireless communication system includes a wireless communication module, and a processor configured to be connected with the wireless communication module, the processor configured to transmit an SR signal to a base station in an SR (scheduling request) transmission resource configured for a UE group to which the user equipment belongs thereto, the processor configured to receive a UL grant from the base station, the processor configured to transmit a UL data signal based on the UL grant. In this case, the SR signal can include information on an identifier of the user equipment.

Preferably, a resource for UL data signal transmission of the UE group is configured via a higher layer signal and the UL grant can include activation information of the UL data signal transmission.

According to embodiments of the present invention, it is able to more efficiently transmit a scheduling request signal in a next generation wireless communication system.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram schematically illustrating a network structure of an evolved universal mobile telecommunications system (E-UMTS) as an exemplary radio communication system;

FIG. 2 is a diagram illustrating structures of a control plane and a user plane of a radio interface protocol between a UE and an evolved UMTS terrestrial radio access network (E-UTRAN) based on the 3GPP radio access network specification;

FIG. 3 is a diagram illustrating physical channels used in a 3GPP system and a general signal transmission method using the same;

FIG. 4 is a diagram illustrating the structure of a radio frame used in a long term evolution (LTE) system;

FIG. 5 is a diagram illustrating the structure of a DL radio frame used in an LTE system;

FIG. 6 is a diagram illustrating the structure of a UL subframe in an LTE system;

FIGS. 7 to 10 are diagrams showing slot level structures of physical uplink control channel (PUCCH) formats 1a and 1b;

FIG. 11 is a flowchart illustrating an example of performing SR transmission according to embodiment of the present invention;

FIG. 12 is a block diagram of a communication apparatus according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, structures, operations, and other features of the present invention will be readily understood from the embodiments of the present invention, examples of which are illustrated in the accompanying drawings. Embodiments which will be described hereinbelow are examples in which technical features of the present invention are applied to a 3GPP system.

Although the embodiments of the present invention will be described based on an LTE system and an LTE-advanced (LTE-A) system, the LTE system and the LTE-A system are purely exemplary and the embodiments of the present invention can be applied to any communication system corresponding to the aforementioned definition. In addition, although the embodiments of the present invention will be described based on frequency division duplexing (FDD), the FDD mode is purely exemplary and the embodiments of the present invention can easily be applied to half-FDD (H-FDD) or time division duplexing (TDD) with some modifications.

In the present disclosure, a base station (eNB) may be used as a broad meaning including a remote radio head (RRH), an eNB, a transmission point (TP), a reception point (RP), a relay, etc.

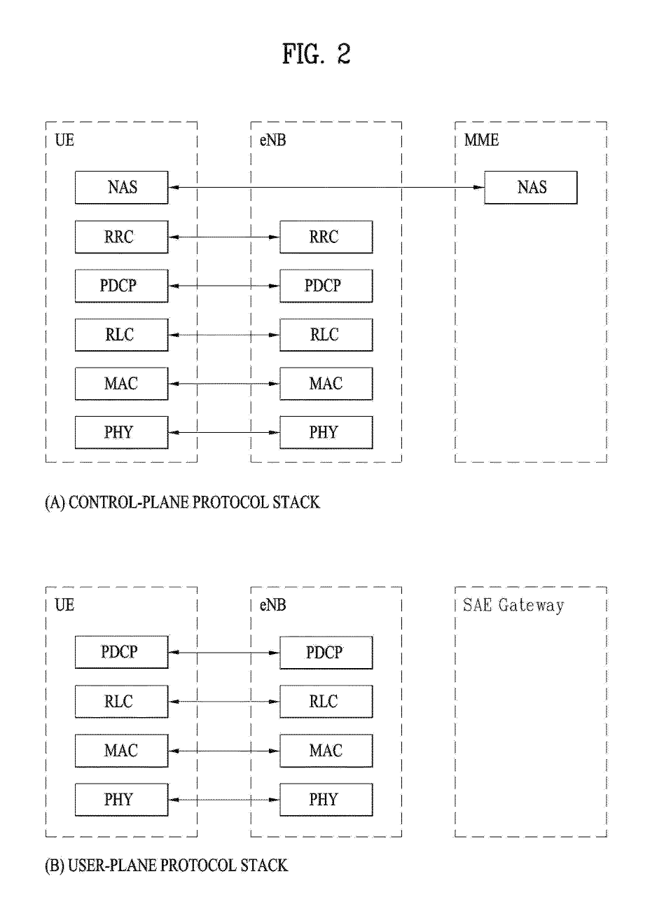

FIG. 2 is a diagram illustrating structures of a control plane and a user plane of a radio interface protocol between a UE and an E-UTRAN based on 3GPP radio access network specifications. The control plane refers to a path used for transmission of control messages, which is used by the UE and the network to manage a call. The user plane refers to a path in which data generated in an application layer, e.g. voice data or Internet packet data, is transmitted.

A physical layer of a first layer provides an information transfer service to an upper layer using a physical channel. The physical layer is connected to a media access control (MAC) layer of an upper layer via a transmission channel. Data is transmitted between the MAC layer and the physical layer via the transmission channel. Data is also transmitted between a physical layer of a transmitter and a physical layer of a receiver via a physical channel. The physical channel uses time and frequency as radio resources. Specifically, the physical channel is modulated using an orthogonal frequency division multiple Access (OFDMA) scheme in DL and is modulated using a single-carrier frequency division multiple access (SC-FDMA) scheme in UL.

The MAC layer of a second layer provides a service to a radio link control (RLC) layer of an upper layer via a logical channel. The RLC layer of the second layer supports reliable data transmission. The function of the RLC layer may be implemented by a functional block within the MAC layer. A packet data convergence protocol (PDCP) layer of the second layer performs a header compression function to reduce unnecessary control information for efficient transmission of an Internet protocol (IP) packet such as an IPv4 or IPv6 packet in a radio interface having a relatively narrow bandwidth.

A radio resource control (RRC) layer located at the bottommost portion of a third layer is defined only in the control plane. The RRC layer controls logical channels, transmission channels, and physical channels in relation to configuration, re-configuration, and release of radio bearers. A radio bearer refers to a service provided by the second layer to transmit data between the UE and the network. To this end, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A non-access stratum (NAS) layer located at an upper level of the RRC layer performs functions such as session management and mobility management.

DL transmission channels for data transmission from the network to the UE include a broadcast channel (BCH) for transmitting system information, a paging channel (PCH) for transmitting paging messages, and a DL shared channel (SCH) for transmitting user traffic or control messages. Traffic or control messages of a DL multicast or broadcast service may be transmitted through the DL SCH or may be transmitted through an additional DL multicast channel (MCH). Meanwhile, UL transmission channels for data transmission from the UE to the network include a random access channel (RACH) for transmitting initial control messages and a UL SCH for transmitting user traffic or control messages. Logical channels, which are located at an upper level of the transmission channels and are mapped to the transmission channels, include a broadcast control channel (BCCH), a paging control channel (PCCH), a common control channel (CCCH), a multicast control channel (MCCH), and a multicast traffic channel (MTCH).

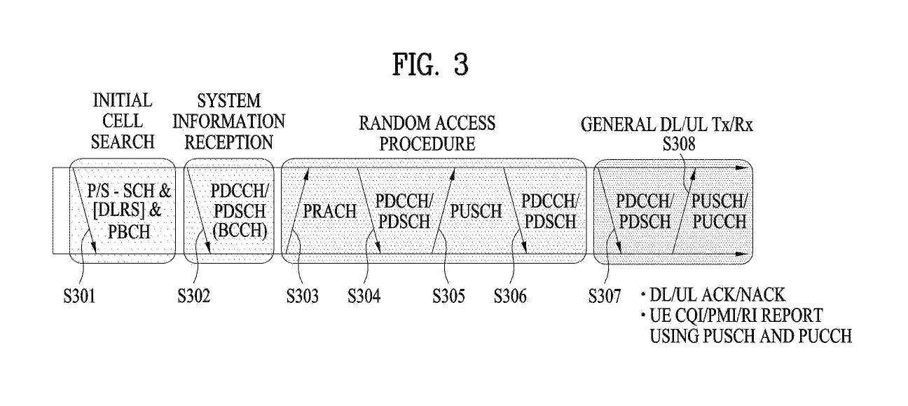

FIG. 3 is a diagram illustrating physical channels used in a 3GPP system and a general signal transmission method using the same.

When power is turned on or the UE enters a new cell, the UE performs an initial cell search procedure such as acquisition of synchronization with an eNB (S301). To this end, the UE may adjust synchronization with the eNB by receiving a primary synchronization channel (P-SCH) and a secondary synchronization channel (S-SCH) from the eNB and acquire information such as a cell identity (ID). Thereafter, the UE may acquire broadcast information within the cell by receiving a physical broadcast channel from the eNB. In the initial cell search procedure, the UE may monitor a DL channel state by receiving a downlink reference signal (DL RS).

Upon completion of the initial cell search procedure, the UE may acquire more detailed system information by receiving a physical downlink control channel (PDCCH) and receiving a physical downlink shared channel (PDSCH) based on information carried on the PDCCH (S302).

Meanwhile, if the UE initially accesses the eNB or if radio resources for signal transmission to the eNB are not present, the UE may perform a random access procedure (S303 to S306) with the eNB. To this end, the UE may transmit a specific sequence through a physical random access channel (PRACH) as a preamble (S303 and S305) and receive a response message to the preamble through the PDCCH and the PDSCH associated with the PDCCH (S304 and S306). In the case of a contention-based random access procedure, the UE may additionally perform a contention resolution procedure.

After performing the above procedures, the UE may receive a PDCCH/PDSCH (S307) and transmit a physical uplink shared channel (PUSCH)/physical uplink control channel (PUCCH) (S308), as a general UL/DL signal transmission procedure. Especially, the UE receives downlink control information (DCI) through the PDCCH. The DCI includes control information such as resource allocation information for the UE and has different formats according to use purpose thereof.

Meanwhile, control information that the UE transmits to the eNB on UL or receives from the eNB on DL includes a DL/UL acknowledgment/negative acknowledgment (ACK/NACK) signal, a channel quality indicator (CQI), a precoding matrix index (PMI), a rank indicator (RI), and the like. In the 3GPP LTE system, the UE may transmit the control information such as CQI/PMI/RI through a PUSCH and/or a PUCCH.

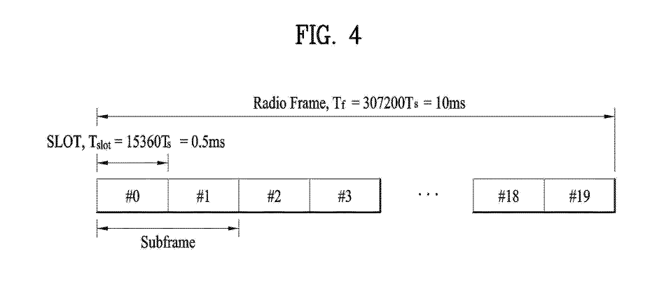

FIG. 4 is a diagram illustrating the structure of a radio frame used in an LTE system.

Referring to FIG. 4, the radio frame has a length of 10 ms (327200×Ts) and includes 10 equal-sized subframes. Each of the subframes has a length of 1 ms and includes two slots. Each slot has a length of 0.5 ms (15360 Ts). In this case, Ts denotes a sampling time represented by Ts=1/(15 kHz×2048)=3.2552×10-8 (about 33 ns). Each slot includes a plurality of OFDM symbols in the time domain and includes a plurality of resource blocks (RBs) in the frequency domain. In the LTE system, one RB includes 12 subcarriers×7 (or 6) OFDM symbols. A transmission time interval (TTI), which is a unit time for data transmission, may be determined in units of one or more subframes. The above-described structure of the radio frame is purely exemplary and various modifications may be made in the number of subframes included in a radio frame, the number of slots included in a subframe, or the number of OFDM symbols included in a slot.

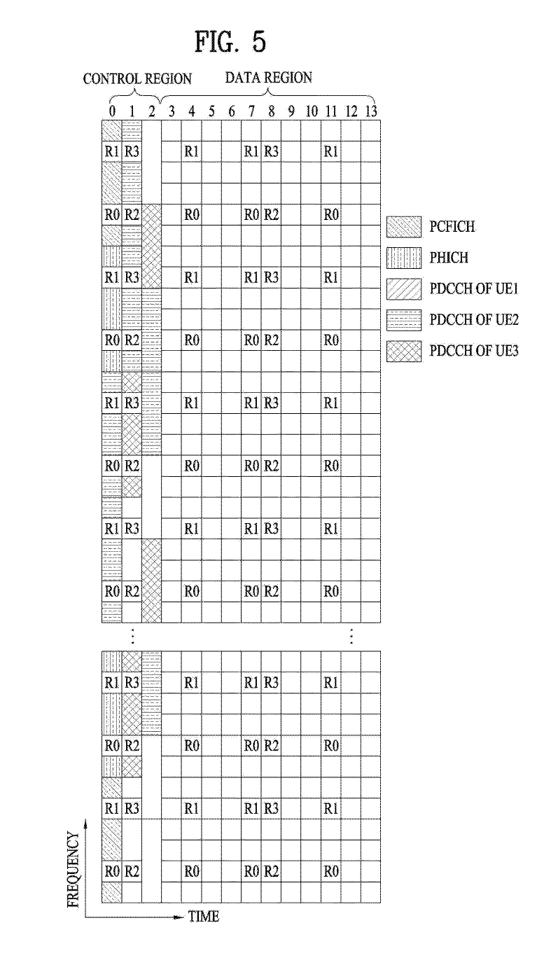

FIG. 5 is a diagram illustrating control channels contained in a control region of one subframe in a DL radio frame.

Referring to FIG. 5, one subframe includes 14 OFDM symbols. The first to third ones of the 14 OFDM symbols may be used as a control region and the remaining 11 to 13 OFDM symbols may be used as a data region, according to subframe configuration. In FIG. 5, R1 to R4 represent reference signals (RSs) or pilot signals for antennas 0 to 3, respectively. The RSs are fixed to a predetermined pattern within the subframe irrespective of the control region and the data region. Control channels are allocated to resources unused for RSs in the control region. Traffic channels are allocated to resources unused for RSs in the data region. The control channels allocated to the control region include a physical control format indicator channel (PCFICH), a physical hybrid-ARQ indicator channel (PHICH), a physical downlink control channel (PDCCH), etc.

The PCFICH, physical control format indicator channel, informs a UE of the number of OFDM symbols used for the PDCCH in every subframe. The PCFICH is located in the first OFDM symbol and is configured with priority over the PHICH and the PDCCH. The PCFICH is composed of 4 resource element groups (REGs) and each of the REGs is distributed over the control region based on a cell ID. One REG includes 4 resource elements (REs). An RE indicates a minimum physical resource defined as one subcarrier by one OFDM symbol. The PCFICH value indicates values of 1 to 3 or values of 2 to 4 depending on bandwidth and is modulated using quadrature phase shift keying (QPSK).

The PHICH, physical hybrid-ARQ indicator channel, is used to carry a HARQ ACK/NACK signal for UL transmission. That is, the PHICH indicates a channel through which DL ACK/NACK information for UL HARQ is transmitted. The PHICH includes one REG and is cell-specifically scrambled. The ACK/NACK signal is indicated by 1 bit and is modulated using binary phase shift keying (BPSK). The modulated ACK/NACK signal is spread with a spreading factor (SF) of 2 or 4. A plurality of PHICHs mapped to the same resource constitutes a PHICH group. The number of PHICHs multiplexed to the PHICH group is determined depending on the number of spreading codes. The PHICH (group) is repeated three times to obtain diversity gain in the frequency domain and/or the time domain.

The PDCCH is allocated to the first n OFDM symbols of a subframe. In this case, n is an integer equal to or greater than 1, indicated by the PCFICH. The PDCCH is composed of one or more control channel elements (CCEs). The PDCCH informs each UE or UE group of information associated with resource allocation of transmission channels, that is, a paging channel (PCH) and a downlink shared channel (DL-SCH), UL scheduling grant, HARQ information, etc. The PCH and the DL-SCH are transmitted through a PDSCH. Therefore, the eNB and the UE transmit and receive data through the PDSCH except for particular control information or service data.

Information indicating to which UE or UEs PDSCH data is to be transmitted and information indicating how UEs should receive and decode the PDSCH data are transmitted on the PDCCH. For example, assuming that a cyclic redundancy check (CRC) of a specific PDCCH is masked by a radio network temporary identity (RNTI) ‘A’ and information about data transmitted using a radio resource ‘B’ (e.g. frequency location) and using DCI format ‘C’, i.e. transport format information (e.g. a transport block size, a modulation scheme, coding information, etc.), is transmitted in a specific subframe, a UE located in a cell monitors the PDCCH, i.e. blind-decodes the PDCCH, using RNTI information thereof in a search space. If one or more UEs having RNTI ‘A’ are present, the UEs receive the PDCCH and receive a PDSCH indicated by ‘B’ and ‘C’ based on the received information of the PDCCH.

FIG. 6 is a diagram illustrating the structure of a UL subframe in an LTE system.

Referring to FIG. 6, an uplink subframe is divided into a region to which a PUCCH is allocated to transmit control information and a region to which a PUSCH is allocated to transmit user data. The PUSCH is allocated to the middle of the subframe, whereas the PUCCH is allocated to both ends of a data region in the frequency domain. The control information transmitted on the PUCCH includes an ACK/NACK, a channel quality indicator (CQI) representing a downlink channel state, an RI for Multiple Input and Multiple Output (MIMO), a scheduling request (SR) indicating a request for allocation of UL resources, etc. A PUCCH of a UE uses one RB occupying different frequencies in each slot of a subframe. That is, two RBs allocated to the PUCCH frequency-hop over the slot boundary. Particularly, PUCCHs for m=0, m=1, m=2, and m=3 are allocated to a subframe in FIG. 6.

In particular, an SR signal is used to make a request for a UL-SCH resource for new transmission. If the SR is triggered, it may consider that the SR is maintained until the SR is cancelled. When a MAC PDU is generated, if the MAC PDU includes BSR including a buffer state of the last event that triggers BSR, or an UL grant is able to accommodate all standby data, all maintained SRs are cancelled and SR prohibition time is terminated. And, if there is no maintaining SR after an SR is triggered, a MAC entity sets an SR COUNTER indicating the count capable of transmitting an SR to 0.

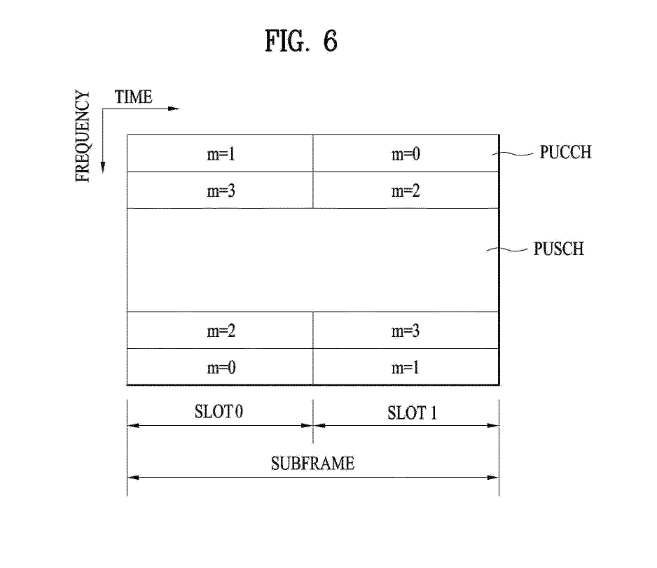

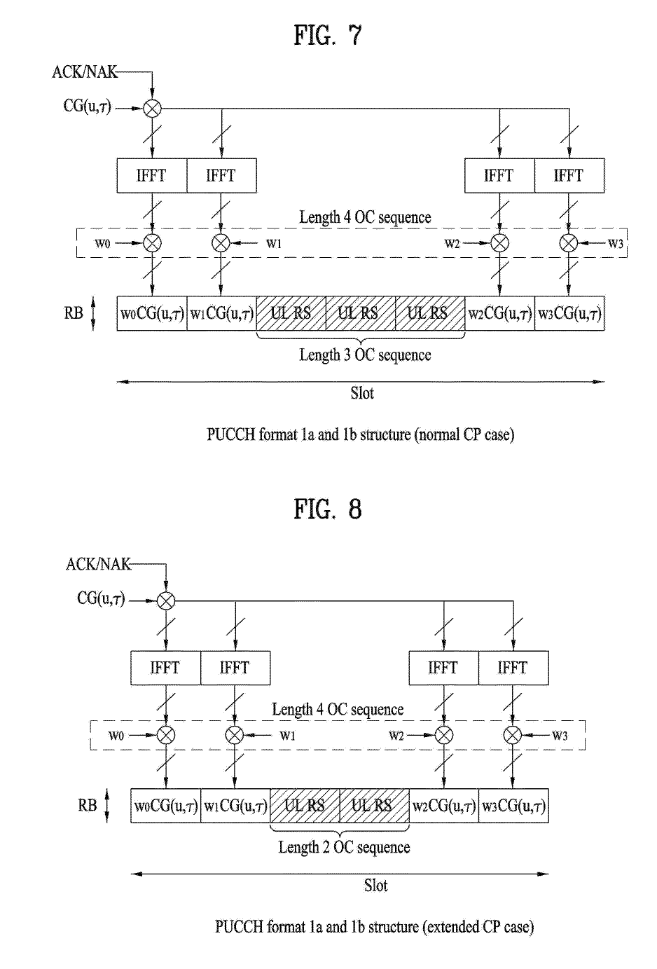

FIGS. 7 to 10 show a slot level structure of a PUCCH format. The PUCCH includes the following formats in order to transmit control information.

(1) (1) Format 1: This is used for on-off keying (OOK) modulation and scheduling request (SR)

(2) Format 1a and Format 1b: They are used for ACK/NACK transmission

1) Format 1a: BPSK ACK/NACK for one codeword

2) Format 1b: QPSK ACK/NACK for two codewords

(3) Format 2: This is used for QPSK modulation and CQI transmission

(4) Format 2a and Format 2b: They are used for CQI and ACK/NACK simultaneous transmission.

FIG. 7 shows PUCCH formats 1a and 1b in the normal CP case. FIG. 8 shows PUCCH formats 1a and 1b in the extended CP case. In the PUCCH formats 1a and 1b, the same control information is repeated within a subframe in slot units. Each UE transmits an ACK/NACK signal through different resources including different cyclic shifts (CSs) (frequency domain codes) of a computer-generated constant amplitude zero auto correlation (CG-CAZAC) sequence and orthogonal covers (OCs) or orthogonal cover codes (OCCs) (time domain codes). The OC includes, for example, a Walsh/DFT orthogonal code. If the number of CSs is 6 and the number of OCs is 3, a total of 18 UEs may be multiplexed in a PRB in the case of using a single antenna. Orthogonal sequences w0, w1, w2 and w3 may be applied in a certain time domain (after FFT modulation) or a certain frequency domain (before FFT modulation).

For SR and persistent scheduling, ACK/NACK resources including CSs, OCs and PRBs may be provided to a UE through radio resource control (RRC). For dynamic ACK/NACK and non-persistent scheduling, ACK/NACK resources may be implicitly provided to the UE by a lowest CCE index of a PDCCH corresponding to a PDSCH.

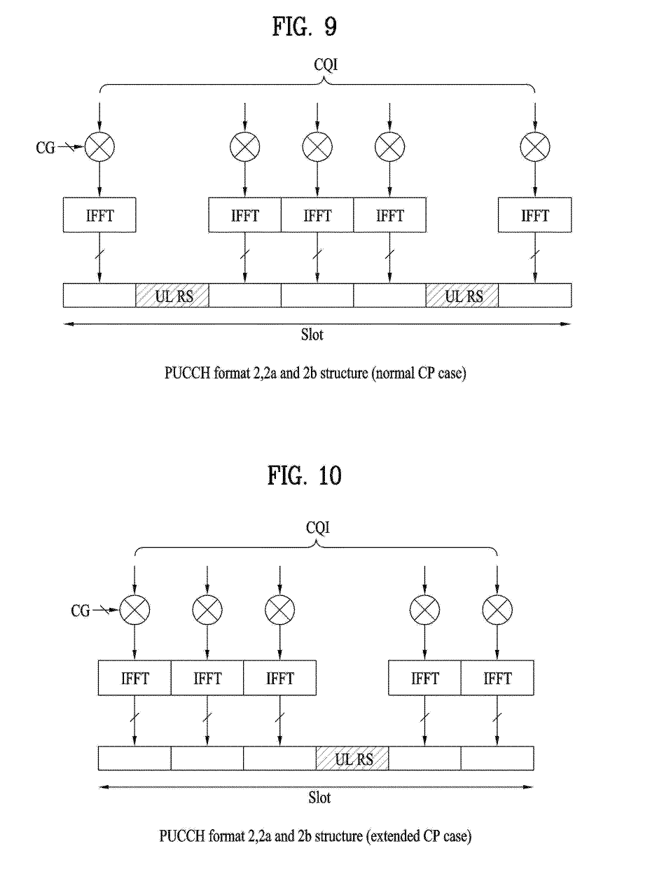

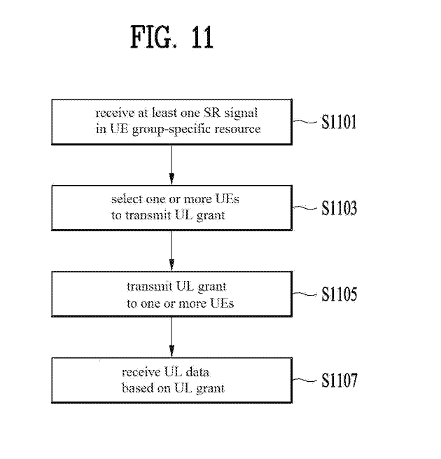

FIG. 9 shows a PUCCH format 2/2a/2b in the normal CP case. FIG. 10 shows a PUCCH format 2/2a/2b in the extended CP case. Referring to FIGS. 9 and 10, one subframe includes 10 QPSK data symbols in addition to an RS symbol in the normal CP case. Each QPSK symbol is spread in a frequency domain by a CS and is then mapped to a corresponding SC-FDMA symbol. SC-FDMA symbol level CS hopping may be applied in order to randomize inter-cell interference. RSs may be multiplexed by CDM using a CS. For example, if it is assumed that the number of available CSs is 12 or 6, 12 or 6 UEs may be multiplexed in the same PRB. For example, in the PUCCH formats 1/1a/1b and 2/2a/2b, a plurality of UEs may be multiplexed by CS+OC+PRB and CS+PRB.

In order to satisfy requirements of various applications, a next generation wireless communication system considers more specifically reducing TTI by changing TTI (transmission time interval) for all or a part of physical channels. And, when a service is provided, in order to reduce total latency, the next generation wireless communication system consider not only reducing the TTI for the physical channel but also enhancing a procedure for UL access. If data to be transmitted from a UE side is changed to an available state, the UL access procedure can be performed in a manner that a UE makes request for a UL grant to an eNB, the eNB transmits a UL grant to the UE, and the UE transmits PUSCH. In order to make the UE immediately transmit PUSCH, the next generation wireless communication system considers enhancing SR (scheduling request) transmission transmitted by the UE.

According to a legacy LTE system, an SR resource is semi-statically configured according to a UE and UE-specific SR resources can be TDM/FDM/CDM. In order to prevent a collision of SR resources between UEs in an identical cell, it may perform SR resource distribution in a conservative manner. Yet, if most of UEs does not perform actual SR transmission, it may have such a problem as the number of reserved SR resources is excessive. On the contrary, if it fails to distribute SR resources not to be overlapped between UEs, a collision may occur between SR transmissions, thereby deteriorating SR detection capability of an eNB. Although an eNB detects an SR, if an unnecessary UL grant is scheduled, it may have a problem that DL overhead increase.

The DL overhead problem also reduces a reserved portion of data RE in shortened TTI, thereby influencing negative impact on throughput. In order to reduce the total latency in the shortened TTI, it may consider a situation of reducing a period between SR resources (e.g., 1 TTI). In this case, an SR resource may have a restriction on a specific cell.

The present invention proposes a method of allocating an SR resource between UEs and a method of transmitting an SR in a situation that SR resources are limitative. And, when an SR is collided with UCI (uplink control information), the present invention proposes a method of simultaneously transmitting the SR and the UCI together with a UE operation. The SR transmission is just an example only. The idea of the present invention can be extensively applied to such different UCI as periodic CSI as well. For clarity, although such an expression as PUCCH/PUSCH/(E)PDCCH/PDSCH, etc. is used, it is apparent that the PUCCH/PUSCH/(E)PDCCH/PDSCH is understood as a name of a physical channel used in a different RAT (radio access technology) or shortened TTI.

<Dynamic Allocation of SR Resource>

First of all, it may consider a method of dynamically changing/updating an SR resource according to a UE.

More specifically, information for updating an SR resource can be transmitted via L1/L2 signaling. In case of L1 signaling, it may consider updating an SR resource via (E)PDCCH/PDSCH. As an example, in an initial stage, an SR resource can be semi-statically configured via higher layer. Subsequently, it may be able to configure dynamic SR resource allocation via a shortened TTI and/or third signaling through higher layer. In this case, the SR resource can be updated using DCI (downlink control information) forwarded via (E)PDCCH. The DCI may correspond to DCI dedicated to a corresponding UE or UE-specific DCI. In the following, embodiments 1) to 4) are described in detail.

### Embodiment 1)

Information on an SR resource is transmitted or updated using DCI. The DCI can be transmitted in a USS (UE specific search space). The DCI can be restricted to DCI for scheduling unicast PDSCH or DCI scrambled by C-RNTI. The DCI newly designates an SR resource via an additional indication field. The SR resource designated by the additional indication field can be designated in a form of a set in advance via higher layer. As a different scheme, information on an SR resource can be transmitted based on a specific combination of DCI. In order to get rid of ambiguity for an SR resource between a UE and an eNB, a new SR resource can be applied only after the eNB receives ACK for PDSCH scheduled by DCI from the UE. Specifically, DCI including SR resource update information may correspond to DCI corresponding to SPS activation or SPS release. Or, the DCI including the SR resource update information may correspond to DCI for sending a TPC command.

### Embodiment 2)

Information on an SR resource is transmitted or updated using DCI. The DCI may correspond to new DCI which is defined to update the SR resource. Of course, the DCI can be used for an additional usage in addition to the usage of updating the SR resource. A UE can transmit HARQ-ACK to an eNB in response to the DCI. In this case, in order to get rid of ambiguity for an SR resource between the UE and the eNB, a new SR resource can be applied only after the eNB receives ACK for the DCI from the UE. Or, the DCI may transmit SR resource update information on a plurality of UEs.

### Embodiment 3)

Information on an SR resource is transmitted or updated using (E)PDCCH transmission scheme. Yet, the (E)PDCCH can be restricted to (E)PDCCH that schedules unicast PDSCH or (E)PDCCH scrambled by C-RNTI. Specifically, the information on the SR resource can be indicated using a scrambling ID and/or a CRC masking sequence and/or (E)CCE (control channel element) index, or the like. And, a list of SR resource candidates is configured via RRC signaling and one SR resource can be indicated from the list using the parameter. In order to get rid of ambiguity for an SR resource between the UE and the eNB, a new SR resource can be applied only after the eNB receives ACK for PDSCH corresponding to (E)PDCCH from the UE. Specifically, (E)PDCCH including SR resource update information may correspond to DCI corresponding to SPS release.

### Embodiment 4)

Information on an SR resource is transmitted or updated using PDSCH transmission scheme. The PDSCH can be restricted to unicast PDSCH or PDSCH scrambled by C-RNTI. Specifically, the information on the SR resource can be indicated using a scrambling ID and/or a CRC masking sequence, or the like. And, a list of SR resource candidates is configured via RRC signaling and one SR resource can be indicated from the list using the parameter. In order to get rid of ambiguity for an SR resource between the UE and the eNB, a new SR resource can be applied only after the eNB receives ACK for PDSCH from the UE.

The embodiment 3) and the embodiment 4) can be used in a manner of being mixed. If (E)PDCCH is missed or PDSCH detection is failed, (1) it may consider maintaining a previously used SR resource or (2) it may assume an initially configured SR resource in RRC as a default SR resource.

When simultaneous transmission of an SR and HARQ-ACK (or other UCI (e.g., CSI)) is permitted, if the SR corresponds to a positive SR, the HARQ-ACK can transmit PUCCH to an updated SR resource. As a different scheme, if HARQ-ACK and an SR are transmitted at the same time, it may be able to transmit PUCCH using a HARQ-ACK resource. In this case, the HARQ and the SR are jointly coded. In order to match a bit size of the HARQ-ACK with a bit size of the SR in an appropriate level, it may apply bundling to the HARQ-ACK using AND operation or the like.

As an example, if a MIMO operation is performed or a bit number of the HARQ-ACK, which is transmitted together with the SR at the same time via TDD or the like, is equal to or greater than 2, it may be able to apply bundling to the HARQ-ACK at the time of simultaneously transmitting the HARQ-ACK and the SR to reduce the bit size. The secured reserved bit can be used for transmitting the SR.

<Contention-Based SR Transmission>

As a different scheme, it may consider a form that a final SR resource is randomly selected by a UE at transmission timing.

Basically, an eNB is able to set information on an SR resource pool to a UE UE-specifically, UE group-specifically, or cell-specifically. Subsequently, the UE can transmit an SR by selecting an SR resource from the SR resource pool at the timing of transmitting the SR (e.g., in an SR subframe/TTI configured via SR subframe/TTI configuration). If the number of UEs at which UL traffic simultaneously occur is sufficiently small and/or a size of the SR resource pool is sufficiently big, it may expect that a probability of collision of an SR resource between UEs at the same time is to be reduced.

Having received the SR, the eNB needs to transmit a UL grant to the UE, which has transmitted the SR. Hence, in case of performing contention-based SR transmission, it is also necessary to know a UE from which an SR is transmitted. In particular, when an SR is transmitted, it is also necessary to transmit information on a UE transmitting the SR. A form of the contention-based SR transmission may have such a form as PUSCH. In this case, the PUSCH is different from a legacy UL grant-based PUSCH or a unicast PUSCH in terms of TTI. If an SR is transmitted in a form of PUSCH, it may be preferable to use a scrambling ID and/or a CRC mask for the PUSCH to identify a UE. Specifically, when the SR is transmitted, the SR can include BSR (buffer status report) information.

If simultaneous transmission of an SR and HARQ-ACK (or, other UCI (e.g., CSI)) is permitted, the SR can transmit PUCCH using a HARQ-ACK resource. In this case, it is preferable to perform joint coding on the HARQ-ACK and the SR. Additionally, in relation to bit sizes of the HARQ-ACK and the SR, it may apply bundling to the HARQ-ACK using AND operation and the like. As a different scheme, if the SR is transmitted in a form of PUSCH, it may be able to map the HARQ-ACK to a physical channel on which the SR is transmitted. In this case, it may have a form that the HARQ-ACK is piggyback to the PUSCH.

<SR Resource Hopping>

It may consider a method of changing an SR resource (or a method of hopping an SR resource) in a single TTI unit or a plurality of TTI units. More specifically, it may be able to differently define a resource hopping pattern according to a UE. Hence, it may be able to define a hopping pattern based on a UE ID and/or C-RNTI and/or a different parameter configured via higher layer. Specifically, a hopping pattern can be provided in a form of a pseudo random sequence having a UE ID and/or C-RNTI and/or a different parameter configured via higher layer as a random seed in a predetermined SR resource index pool or an SR resource index pool configured via higher layer. And, the SR resource index pool can be UE group-specifically or cell-specifically configured.

According to the present scheme, it may also be able to probabilistically avoid an SR resource collision according to timing of transmitting an SR transmitted by a UE. If SR resources are collided with each other at specific timing, it is highly probable that a collision does not occur in a next SR subframe/TTI. The above-mentioned scheme is superior to the dynamic SR resource allocation in terms of an ambiguity problem between an eNB and a UE and the above-mentioned scheme is superior to the contention-based SR resource allocation in terms of an ambiguity problem for an entity of transmitting an SR at an eNB end.

Similarly, when simultaneous transmission of an SR and HARQ-ACK (or, other UCI (e.g., CSI)) is permitted, if the SR corresponds to a positive SR, the HARQ-ACK can transmit PUCCH to an updated SR resource. As a different scheme, if the HARQ-ACK and the SR are transmitted at the same time, it may transmit PUCCH using a HARQ-ACK resource. In this case, the HARQ-ACK and the SR are jointly coded. In order to match a bit size of the HARQ-ACK with a bit size of the SR in an appropriate level, it may apply bundling to the HARQ-ACK using AND operation or the like.

If a MIMO operation is performed or a bit number of the HARQ-ACK, which is transmitted together with the SR at the same time via TDD or the like, is equal to or greater than 2, it may be able to apply bundling to the HARQ-ACK at the time of simultaneously transmitting the HARQ-ACK and the SR to reduce the bit size. The secured reserved bit can be used for transmitting the SR.

<Collision Between SR Resources>

SR resource collision may occur irrespective of whether or not SR transmission is enhanced. The SR resource collision may correspond not only to a case that UEs different from each other practically transmit an SR using the same resource, but also to a case that a plurality of UEs share the same SR resource at the same time. In this case, if a specific UE transmits an SR to an eNB, the eNB is unable to know a UE from which the SR is transmitted using an SR resource only. As a result, the eNB may excessively transmit UL grant to UEs. Moreover, having received the UL grant, the UEs may unnecessarily transmit PUSCH.

Hence, if a UE receives a UL grant from the eNB despite not transmitting an SR, the UE may not perform UL transmission by ignoring the UL grant. However, if there exists information (e.g., PHR (power headroom report) or BSR) to be transmitted by the UE at the timing of receiving the UL grant, the UE may transmit PUSCH according to the UL grant, even though the UE did not transmit the SR.

In case of a UL grant provided to a UE according to a contention-based SR, the UL grant can be transmitted in a form of contention-based PUSCH. Specifically, the UL grant may have a form of being individually transmitted to all UEs corresponding to the SR or a form of a group-specific UL grant. Of course, in case of a UE-specific UL grant, a contention level can be determined by a network. In particular, if a type of a UL grant triggered by an SR is different from a type of a general UL grant, a UE may perform operation of the present invention.

Or, a UL grant triggered by an SR may correspond to SPS PUSCH of a contention-based PUSCH form. In particular, SPS configuration can be provided by higher layer in advance and a UL grant for an SR may correspond to an SPS activation message.

Additionally, when a UE transmits an SR to an eNB, the UE may transmit (partial) information on the UE to the eNB together with the SR at the same time. For example, when the UE transmits PUCCH to the eNB as an SR resource, the UE applies modulo calculation to a UE ID or C-RNTI to generate a modulated symbol and maps the modulated symbol to the SR at the time of transmitting the SR. Yet, the above-mentioned scheme can be restricted to a case that an SR is transmitted only at corresponding timing. And, the above-mentioned scheme can be restricted to a case that PUCCH is divided into an RS (reference signal) and a data part.

As a further different scheme, it may consider scheduling a UL grant for a part of UEs (e.g., one UE) only among UEs corresponding to an SR resource. As a reference for selecting a UE, it may be able to compare a channel state or a channel gain value on the basis of a DMRS and/or an SRS of PUCCH/PUSCH, which is transmitted at previous timing to each UE corresponding to the same SR resource, to select a UE. If an eNB does not select a UE, which has actually transmitted an SR, it is preferable that the UE transmits the SR again. SR retransmission may ignore prohibit time for an SR.

<Aperiodic SR Triggering Via DL Scheduling Grant>

If a network initiates transmission (e.g., TCP session initiation (TCP session start) in a situation that a period of actually transmitting an SR or a period of triggering an SR is relatively long, time to the timing at which the SR is transmitted can be relatively long. Hence, in order to transmit the SR and A/N at the same time, it may be able to aperiodically trigger the SR. The SR triggering can be provided by (E)PDCCH/PDCCH corresponding o DL assignment. When the SR is triggered, a UE can transmit the SR and the A/N at the same time.

FIG. 11 is a flowchart illustrating an example of performing SR transmission according to embodiment of the present invention. In particular, in FIG. 11, assume that an SR transmission resource is common to a UE group consisting of a plurality of UEs.

Referring to FIG. 11, in the step S1101, an eNB receives at least one SR signal in an SR transmission resource configured for a UE group. Subsequently, in the step S1103, the eNB can select one or more UEs to transmit a UL grant based on the at least one SR signal. In this case, in order to identify a UE, which have transmitted the SR signal, it is preferable to include information on an identifier of the UE, which have transmitted the SR signal, in the SR signal.

Additionally, when the UE is selected, it may also consider information on a channel state between the UE and the eNB. For example, it may consider a channel state or a channel gain value based on a DMRS and/or an SRS of PUCCH/PUSCH which is transmitted at previous timing for each UE.

Subsequently, in the step S1105, the eNB transmits a UL grant to the selected UE. In the step S1107, the eNB can receive a UL data signal based on the UL grant. Of course, it may be preferable that a UE transmitting the UL data signal corresponds to the UE, which have transmitted the SR signal, among a plurality of UEs belonging to the UE group.

More preferably, a resource for transmitting a UL data signal of a UL group can be configured in advance via higher layer signaling. In this case, the UL grant of the present invention can include activation information of the UL data signal transmission, i.e., triggering information of the UL data signal.

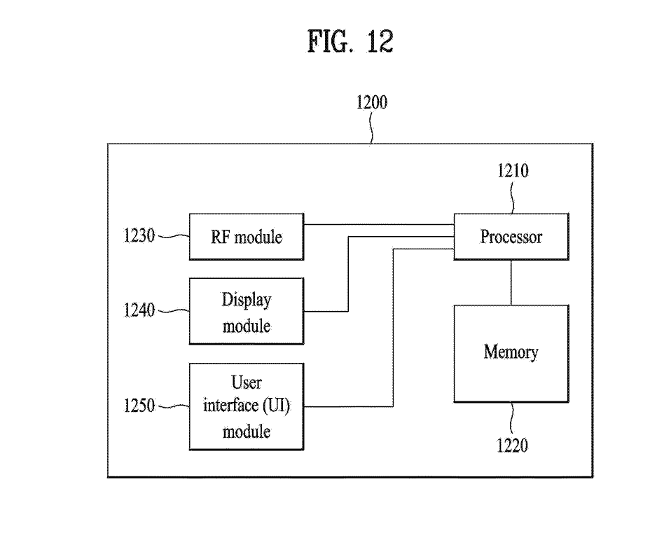

FIG. 12 is a block diagram of a communication apparatus according to an embodiment of the present invention.

Referring to FIG. 12, a communication apparatus 1200 includes a processor 1210, a memory 1220, an RF module 1230, a display module 1240, and a User Interface (UI) module 1250.

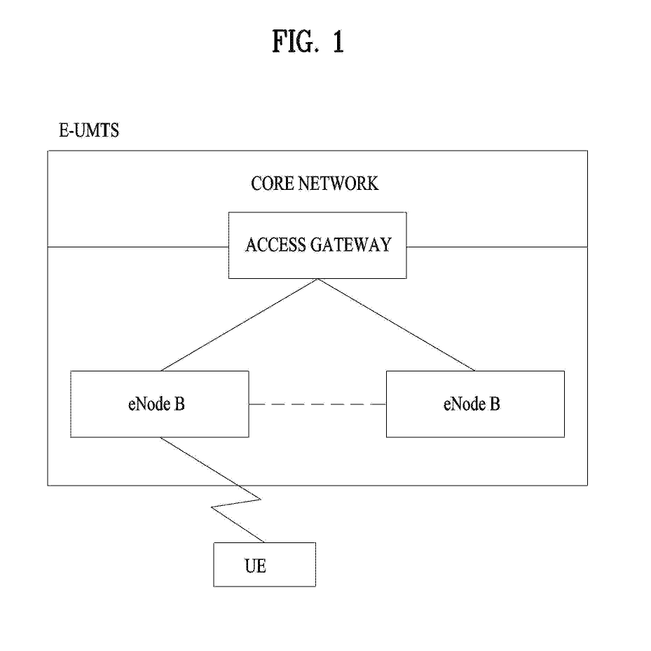

The communication device 1200 is shown as having the configuration illustrated in FIG. 12, for the convenience of description. Some modules may be added to or omitted from the communication apparatus 1200. In addition, a module of the communication apparatus 1200 may be divided into more modules. The processor 1210 is configured to perform operations according to the embodiments of the present invention described before with reference to the drawings. Specifically, for detailed operations of the processor 1210, the descriptions of FIGS. 1 to 11 may be referred to.

The memory 1220 is connected to the processor 1210 and stores an Operating System (OS), applications, program codes, data, etc. The RF module 1230, which is connected to the processor 1210, upconverts a baseband signal to an RF signal or downconverts an RF signal to a baseband signal. For this purpose, the RF module 1230 performs digital-to-analog conversion, amplification, filtering, and frequency upconversion or performs these processes reversely. The display module 1240 is connected to the processor 1210 and displays various types of information. The display module 1240 may be configured as, not limited to, a known component such as a Liquid Crystal Display (LCD), a Light Emitting Diode (LED) display, and an Organic Light Emitting Diode (OLED) display. The UI module 1250 is connected to the processor 1210 and may be configured with a combination of known user interfaces such as a keypad, a touch screen, etc.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

A specific operation described as performed by a BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘Access Point (AP)’, etc.

The embodiments of the present invention may be achieved by various means, for example, hardware, firmware, software, or a combination thereof. In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

According to an embodiment of the present invention, it is possible to efficiently report feedback information for division beamforming in a wireless communication system.

It will be appreciated by persons skilled in the art that that the effects that can be achieved through the present invention are not limited to what has been particularly described hereinabove and other advantages of the present invention will be more clearly understood from the following detailed description.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method of transmitting and receiving a signal by a base station in a wireless communication system, the method comprising:
receiving at least one SR signal in an SR (scheduling request) transmission resource configured for a plurality of user equipments (UEs);
selecting at least one UE for transmitting an uplink grant based on the at least one SR signal; and
transmitting the uplink grant to the at least one UE.

2. The method of claim 1, further comprising receiving an uplink data signal from the at least one UE based on the uplink grant,
wherein the at least one UE corresponds to a UE which have transmitted the at least one SR signal.

3. The method of claim 1, further comprising configuring a resource for an uplink data signal transmission of the plurality of the UEs via a higher layer signal,
wherein the uplink grant comprises activation information of the uplink data signal transmission.

4. The method of claim 1, wherein the at least one SR signal comprises information on an identifier of a UE which have transmitted the SR signal.

5. The method of claim 1, wherein selecting the at least one UE comprises selecting the at least one UE based on channel state information corresponding to the plurality of the UEs.

6. A method of transmitting and receiving a signal by a user equipment (UE) belonging to a UE group in a wireless communication system, the method comprising:
transmitting an SR signal to a base station in an SR (scheduling request) transmission resource configured for the UE group;
receiving an uplink grant from the base station; and
transmitting an uplink data signal based on the uplink grant,
wherein the SR signal comprises information on an identifier of the UE.

7. The method of claim 6, further comprising configuring a resource for an uplink data signal transmission of the UE group via a higher layer signal,
wherein the uplink grant comprises activation information of the uplink data signal transmission.

8. A base station in a wireless communication system, the base station comprising:
a wireless communication module; and
a processor configured to be connected with the wireless communication module, the processor configured to receive at least one SR signal in an SR (scheduling request) transmission resource configured for a plurality of UEs, the processor configured to select at least one UE for transmitting an uplink grant based on the at least one SR signal, the processor configured to transmit the uplink grant to the at least one UE.

9. The base station of claim 8, wherein the processor is configured to receive an uplink data signal from the at least one UE based on the uplink grant and wherein the at least one UE corresponds to a UE which have transmitted the at least one SR signal.

10. The base station of claim 8, wherein the processor is configured to configure a resource for uplink data signal transmission of the plurality of the UEs via a higher layer signal and wherein the uplink grant comprises activation information of the uplink data signal transmission.

11. The base station of claim 8, wherein the at least one SR signal comprises information on an identifier of a UE which have transmitted the SR signal.

12. The base station of claim 8, wherein the processor is configured to select the at least one UE based on channel state information corresponding to the plurality of the UEs.

13. A user equipment in wireless communication system, the user equipment comprising:
a wireless communication module; and
a processor configured to be connected with the wireless communication module, the processor configured to transmit an SR signal to a base station in an SR (scheduling request) transmission resource configured for a UE group to which the user equipment belongs thereto, the processor configured to receive an uplink grant from the base station, the processor configured to transmit an uplink data signal based on the uplink grant,
wherein the SR signal comprises information on an identifier of the user equipment.

14. The user equipment of claim 13, wherein the processor is configured to configure a resource for an uplink data signal transmission of the UE group via a higher layer signal and wherein the uplink grant comprises activation information of the uplink data signal transmission.
